(19) United States
(12) Patent Application Publication
(10) Pub. No.: US 2011/0164271 A1
(43) Pub. Date: Jul. 7, 2011

(54) IMAGE PROCESSING APPARATUS AND METHOD FOR MONITORING JOBS

(75) Inventor: Kazuhiro Kamimura, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/977,368

(22) Filed: Dec. 23, 2010

Related U.S. Application Data
(60) Provisional application No. 61/292,057, filed on Jan. 4, 2010.

(51) Int. Cl. G06K 15/00

(52) U.S. Cl. 358/1.14

(57) ABSTRACT

According to one embodiment, an image forming apparatus including, an authenticating unit configured to specify a user, a determining unit configured to determine a permission level given to the user specified by the authenticating unit, and a managing unit configured to manage, according to the permission level determined by the determining unit, information permitted to be disclosed, notified, or displayed to the user specified by the authenticating unit.

### CROSS-REFERENCE TO RELATED APPLICATIONS

This application is based upon and claims the benefit of priority from: U.S. Provisional Application No. 61/292,057 filed on Jan. 4, 2010, the entire contents of each of which are incorporated herein reference.

### FIELD

Embodiments described herein relates generally to an image forming apparatus and a method for monitoring jobs.

### BACKGROUND

An image forming apparatus called MFP (Multi-Functional Peripheral) visualizes input data and outputs the input data onto a sheet medium.

The input data includes image data and any one of photographic data and text data or both and the like. The input data can be input to the MFP through a network or by user operation (directly).

Image formation based on the input data, i.e., each of operations for visualizing the input data and outputting the input data onto the sheet medium is a job. A user can check a history (a log) concerning each job.

The history includes various kinds of information such as a data supply source (client or user) name, a sheet medium size, and the number of sheets and, if data has a peculiar name, the name, i.e., a document name.

Histories are also present in jobs instructed by other users different from the user who is about to check the history.

Therefore, for example, when a user who instructs a job displays a history, the user can unintentionally check histories of jobs instructed by other users.

### BRIEF DESCRIPTION OF THE DRAWINGS

FIG. 1 is an exemplary diagram showing an example of an MFP and a network system according to an embodiment;

FIG. 2 is an exemplary diagram showing an example of user authentication according to an embodiment;

FIG. 3 is an exemplary diagram showing a “display example” according to an embodiment;

FIG. 4A is an exemplary diagram showing a “display example” according to an embodiment;

FIG. 4B is an exemplary diagram showing a “display example” according to an embodiment;

FIG. 5 is an exemplary diagram showing an example of user authentication according to an embodiment;

FIG. 6 is an exemplary diagram showing a “display example” according to an embodiment; and

FIG. 7 is an exemplary diagram showing an example of a method for disclosing (notifying or displaying) any one of content and a result or both of a job.

### DETAILED DESCRIPTION

In general, according to one embodiment, an image forming apparatus comprising: an authenticating unit configured to specify a user; a determining unit configured to determine a permission level given to the user specified by the authenticating unit; and a managing unit configured to manage, according to the permission level determined by the determining unit, information permitted to be disclosed, notified, or displayed to the user specified by the authenticating unit.

Embodiments will now be described hereinafter in detail with reference to the accompanying drawings.

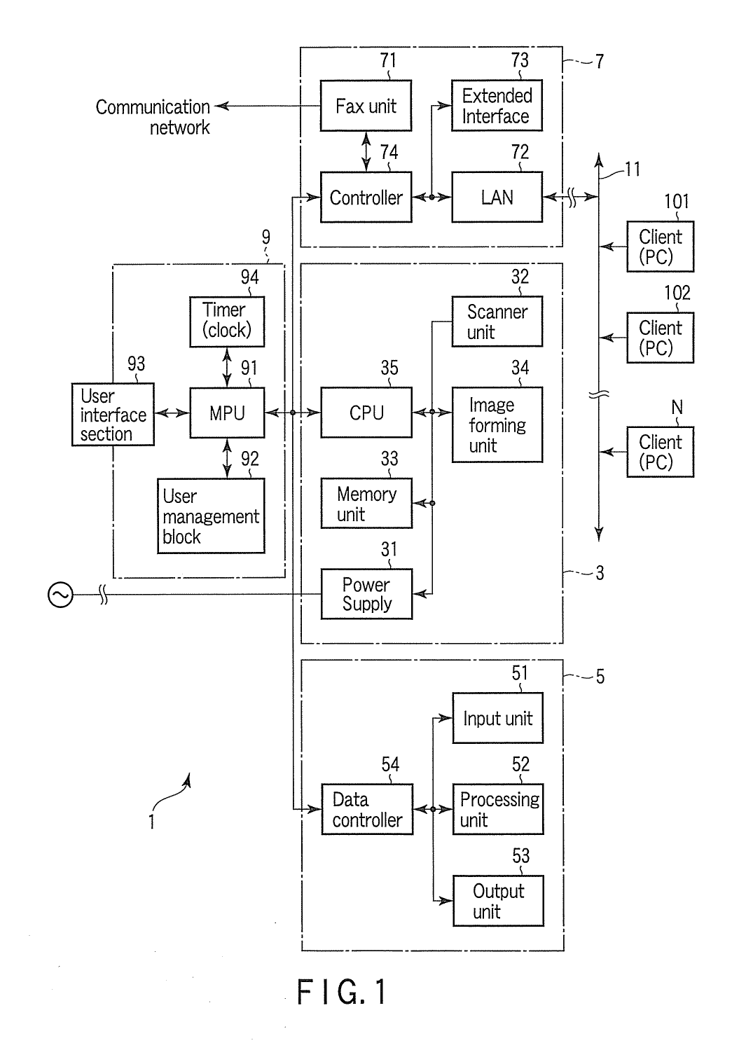

FIG. 1 shows an example of an outline of an MFP (Multi-Functional Peripheral, an electronic apparatus).

An MFP 1 includes at least an image forming section 3, a data managing section 5, a communication control section 7, and a system control section 9. The image forming section 3 visualizes an image or a character on the basis of data of an arbitrary format and outputs the image or the character onto a sheet medium. The data managing section 5 receives data and manages the data for execution of a job such as print output or storage. The communication control section 7 manages transmission and reception of the data to and from a communication line (a network). The system control section 9 controls the operation of the image forming section 3, the data managing section 5, and the communication control section 7, i.e., the MFP 1.

The MFP 1 is connected to an arbitrary number of users (clients) 101, 102, . . . , and N via a network 11. The users (clients) 101, 102, . . . , and N are, for example, personal computers (PC), tablet PCs, or smart phones (high-function portable terminals also called PDA (Personal Digital Assistant)). The users (clients) 101, 102, . . . , and N handle image data, any one of photographic data and text data or both, and the like.

The image forming section 3 includes at least a power supply unit 31, a scanner unit 32, a memory unit 33, an image forming unit 34, and a process control unit (a process controller) 35 configured to control the units of the image forming section 3.

The power supply unit 31 is connected to a commercial power supply and generates a secondary voltage used for the operation of the MFP 1 (from a primary voltage).

If a format of information such as an image, a character, a shape, or a color visualized and output onto a sheet medium by the image forming unit 34 is a non-data format, the scanner unit 32 outputs the information as image data. The scanner unit 32 irradiates light on a sheet-like original document or a three-dimensional object including information, acquires an electric signal corresponding to the intensity of the light reflected on the information (image light), and converts the electric signal into image data.

The memory unit 33 stores the image data obtained by the scanner unit 32 or image data input from the outside. The memory unit 33 also stores a computer program, an application (software), an address table (address book data) explained later, or the like.

The image forming unit 34 visualizes the image data and outputs the image data onto a sheet medium. As a method for visualization, an electrostatic transfer system for visualizing the image data using a toner and a direct recording system for visualizing the image data using ink are often used. A hot stamp or the like for output of special colors (gold and silver) may be used together with the method.

The image forming section 3 stores an image output by the image forming unit 34. The image forming section 3 includes a feeding mechanism for the sheet medium fed to the image forming unit 34.

The data managing section 5 includes at least a data input unit 51 configured to receive data, a data processing unit 52 configured to process, for execution of a job such as print output or storage, the data received by the data input unit 51, a data output unit 53 configured to output the data processed by the data processing unit 52 in a format specified by the job, and a data control unit (a data controller) 54 configured to control exchange of the data among the data input unit 51, the data processing unit 52, and the data output unit 53.

The communication control section 7 includes at least a facsimile (communication) unit 71 connected to a public communication line and configured to receive or transmit facsimile data, a LAN (communication) unit 72 connected to an external network such as a LAN (Local Area Network) and configured to receive or transmit data from or to a network, an extended interface unit 73 conforming to, for example, a USB (Universal Serial Bus) standard and configured to receive or transmit data from or to a partner connected to the extended interface unit 73, and a communication control unit (a communication controller) 74 configured to control communication with the partner, input, output, and parallel processing for data, and the like by each of the facsimile (communication) unit 71, the LAN (communication) unit 72, and the extended interface unit 73.

The system control section 9 includes at least a main control block (MPU) 91 and a user use management block 92. The MPU 91 is connected to the process controller (CPU) 35 (the image forming section 3), the data controller 54 (the data managing section 5), and the communication controller 74 (the communication control section 7) and controls the sections. The user use management block 92 manages permission for use of the MFP 1, permission for a usable function for, for example, each user, authority for a change of setting or the like, authority concerning job monitoring explained later, and the like.

The MPU 91 is connected to a user interface section 93 and outputs, while receiving an instruction input for start or stop of the operation of the sections, condition setting, or the like from an input panel area included in the user interface section 93, a control signal for controlling the operation of the sections according to the instruction input. The input panel area of the user interface section 93 is desirably, for example, a touch panel type in which a display area is integrally formed. The user interface section 93 includes a function as an authentication unit for authentication of a user, for example, a face recognition unit configured to recognize a characteristic of the face of the user, a biometric recognition unit configured to authenticate the user using a biometric characteristic of a palm, a finger, or the like, or a card reader configured to use identification information recorded in a card when a medium such as an ID card is used. The authentication unit of the user interface section 93 can easily detect a medium for authentication that is an instruction input for user authentication. For example, when identification information (the medium for authentication) is an ID card, a reading section is prepared in, for example, an armor housing of the scanner unit 32. The medium for authentication (personal authentication) may be a radio ID card. When the medium for authentication is the radio ID card, an antenna and an authentication processing circuit that can input an input signal, i.e., an authentication result to the user interface section 93 are prepared in the armor housing of the scanner unit 32.

The MPU 91 is connected to a timer unit 94. The timer unit 94 stores year (yyy), month (mm), day (dd), hour (hh), and minute (mm) on the basis of a clock generated by a clock generating section (CLK) 94-1. The clock generating section (CLK) 94-1 may be provided in the system control section 9 for the operation of the MPU 91. For counting of time or storage of time data by the timer unit 94, for example, a frequency of a commercial power supply input to the power supply unit 31 of the image forming section 3 may be used or time data (a time tone service signal) included in a broadcast signal (of a space wave) may be directly received.

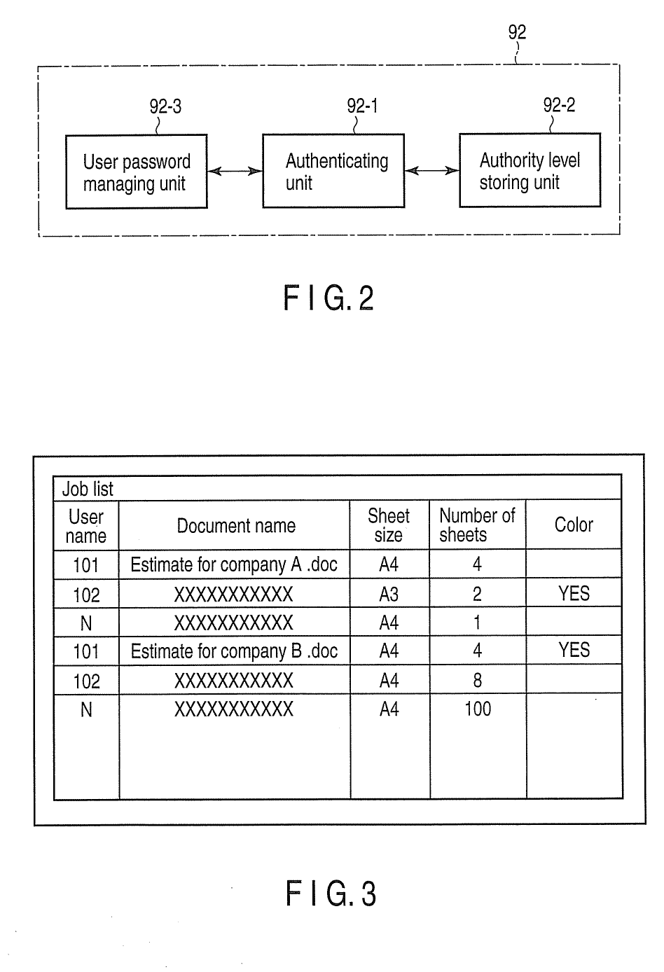

The arbitrary users (clients) 101, 102, . . . , and N can instruct the MFP 1 to perform print out (output of visualized image data, any one of photographic data and text data or both, or the like to a sheet medium) and facsimile transmission. The users can capture facsimile data received by the MFP 1 or image data, photographic data, or the like acquired by the scanner unit 32. The users can refer to a history of jobs (monitor jobs) by accessing the MFP 1. The users can also directly check the history from the user interface section 93 of the MFP 1. Authority for the job monitoring is determined for each of the users according to an authenticating unit 92-1 and “authority levels” stored by an authority level storing unit (a permission memory) 92-2 and referred to by the authenticating unit 92-1 explained below with reference to FIG. 2 included in the user management block 92.

FIG. 2 shows an example of components of the user management block 92.

The user management block 92 includes the authenticating unit 92-1 and the authority level storing unit 92-2. The authority level storing unit 92-2 stores information concerning authority levels for monitoring of the jobs for each of the users, i.e., jobs respectively concerning image formation based on input data (operation for visualizing the input data and outputting the input data onto a sheet medium), facsimile transmission, capturing of image data, photographic data, or the like acquired by the scanner unit 32, and the like. The authority level storing unit 92-2 may be provided in, for example, the memory unit 33 included in the image forming section 3 and referred to by the user management block 92 when job monitoring is requested.

When the arbitrary users (clients) 101, 102, . . . , and N request job monitoring, content of job monitoring for each of the users is set with reference to authority of each of the users stored by the authority level storing unit 92-2 in the authenticating unit 92-1. Therefore, content and results of jobs are notified to each of the users, who request the job monitoring, in a range in which the user can refer to the content and the results of the jobs. If the user requests the monitoring directly from the user interface section 93 of the MFP 1, the content of the jobs is displayed on the touch panel of the user interface section 93. If the user includes a display mechanism, the user can directly acquire a “display example” through the network 11 (the “display example” is displayed on the display mechanism of the user).

FIG. 3 shows a “display example” for notifying, when the arbitrary user (client) 102 who is not an administrator requests job monitoring, content and results of jobs to each of users who request job monitoring in a range in which the user can refer to the content and the results of the jobs.

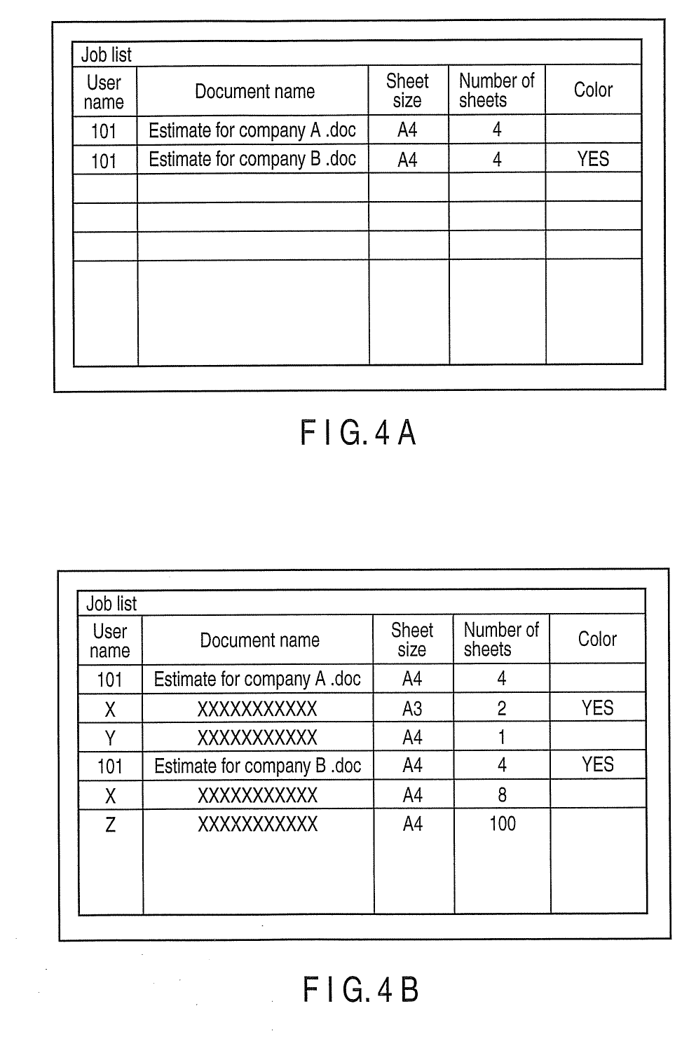

For an arbitrary user who is not an administrator, information related to a job of the user and information that all users are permitted to check are disclosed (notified or displayed). Specifically, in the example shown in FIG. 3, all kinds of information related to the job of the user 102 are disclosed. However, concerning information related to jobs of the other users, information such as time required for processing of jobs that the user 102 “may be able to know (permitted to know)” is disclosed. In other words, when an arbitrary user who is not an administrator requests job monitoring, a “history of jobs” to be disclosed can be limited according to necessity (a part of the “history of jobs” to be disclosed can be undisclosed). As in an example shown in FIG. 4A, when an arbitrary user who is not an administrator requests job monitoring, only information related to the user who requests the job monitoring can also be disclosed (the disclosure can be managed by firmware of the MPU 91 or the authority stored using the authority level storing unit 92-2). As indicated by an example shown in FIG. 4B, concerning the information related to the jobs of the other users, it is also possible to adopt “user name conversion display” for making it difficult to specify user names such as X, Y, and Z. The “user name conversion display” can be prepared as firmware of the MPU 91, an application of the authenticating unit 92-1, or the like.

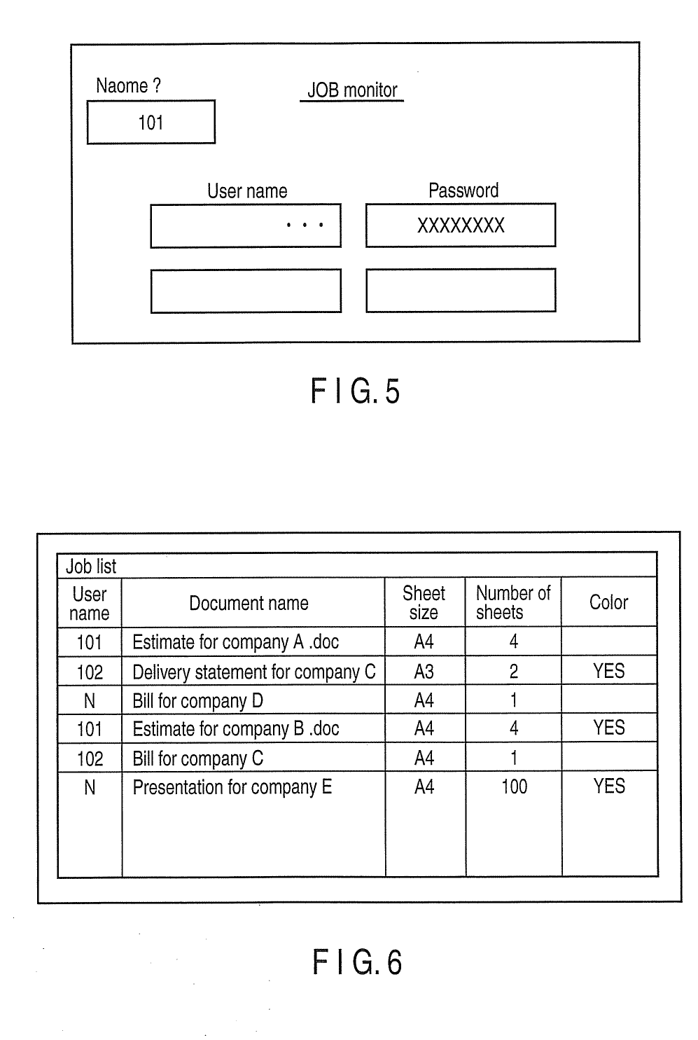

“User authentication (job monitoring)” by the authenticating unit 92-1 is managed using, for example, user names and passwords. For example, if a user name and a password input through an authentication screen shown in FIG. 5 can be determined as “authentication permitted” in the authenticating unit 92-1, “content and a result of a job” permitted to a user who requests job monitoring is displayed (notified or disclosed). The passwords are stored in a user password management table 92-3 connected to the authenticating unit 92-1. In addition to update of the passwords by the users, update of the passwords by an administrator is also possible. The user password management table 92-3 may be incorporated in, for example, the memory unit 33.

FIG. 6 shows a display (notification or disclosure) example performed when a user who requests job monitoring is an administrator. This display (notification or disclosure) example is “display” in which “content and results of jobs” of all users can be grasped.

For example, if a service crew requests job monitoring, it is desirable that all kinds of information excluding information concerning user names and departments of users are displayed. Information such as time when a jam (an output mistake of a sheet medium) occurs or a toner (a visualizing agent) is supplied may be displayed (disclosed or notified).

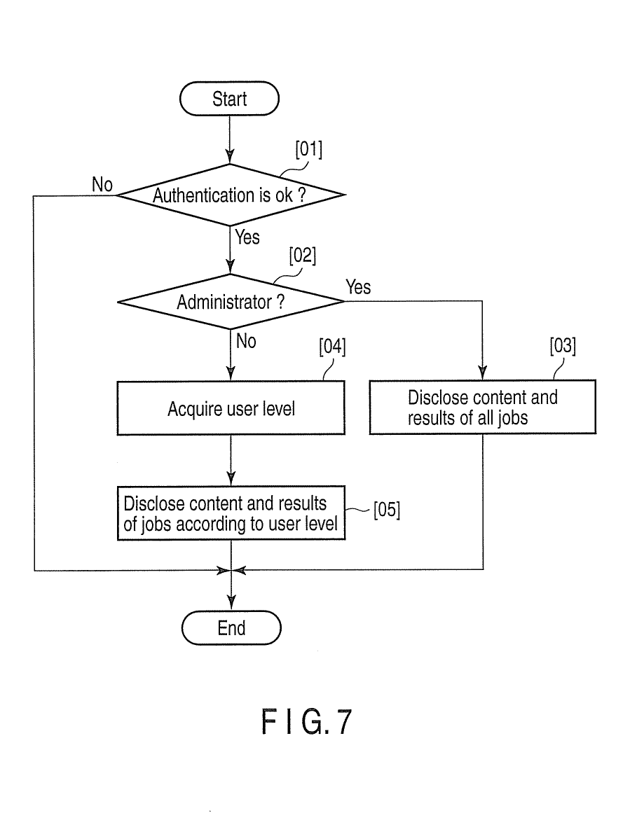

FIG. 7 shows an example of a procedure for displaying (notifying or disclosing) “content and a result of a job” in response to a request for job monitoring.

When a user requests job monitoring, the authenticating unit 92-1 checks, according to input user name and password or user information specified by an authentication medium such as an ID card, whether the user is a user permitted to monitor a job (user authentication [01])

If the user is a user permitted to monitor a job [Yes in 01], the authenticating unit 92-1 checks whether the user is an administrator [02].

If the user is an administrator [YES in 02], the authenticating unit 92-1 discloses (notifies or displays) content and results of all jobs [03].

If the user is a non-administrator [NO in 02], the authenticating unit 92-1 acquires an authority level (permission information) for the user who requests the job monitoring [04].

The authenticating unit 92-1 discloses (notifies or displays), according to the acquired authority level (permission information), content and results of jobs in a range in which the user can refer to the content and the results of the jobs [05].

By applying the embodiment, a user who requests job monitoring is distinguished and a job related to the user and jobs related to other users are displayed to be divided. This makes it possible to keep privacy among the users and improve security.

If a type of a job is printing or the like, it is possible to predict how long a waiting time is without predicting information that may relate to privacy such as which users perform printing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an authenticating unit configured to specify a user;
a determining unit configured to determine a permission level given to the user specified by the authenticating unit; and
a managing unit configured to manage, according to the permission level determined by the determining unit, information permitted to be disclosed, notified, or displayed to the user specified by the authenticating unit.

2. The apparatus of claim 1, wherein the managing unit enables disclosure, notification, or display of only information related to the user specified by the authenticating unit.

3. The apparatus of claim 1, wherein the managing unit enables disclosure, notification, or display of information related to the user specified by the authenticating unit and information permitted to be disclosed, notified, or displayed to all users.

4. The apparatus of claim 2, the managing unit enables disclosure, notification, or display of information concerning a user different from the user specified by the authenticating unit using a disclosure, notification, or display rule for not specifying the different user.

5. The apparatus of claim 3, wherein the managing unit enables disclosure, notification, or display of information concerning a user different from the user specified by the authenticating unit using a disclosure, notification, or display rule for not specifying the different user.

6. The apparatus of claim 1, wherein the information includes information concerning a waiting time for a job.

7. The apparatus of claim 2, wherein the information includes information concerning a waiting time for a job.

8. The apparatus of claim 3, wherein the information includes information concerning a waiting time for a job.

9. The apparatus of claim 4, wherein the information includes information concerning a waiting time for a job.

10. The apparatus of claim 5, wherein the permitted information includes information concerning a waiting time for a job.

11. A system for image processing comprising:
a managing apparatus configured to disclose, to a user who requests disclosure, information at a level permitted to the user, the managing apparatus including:
an authenticating unit configured to specify a user;
a determining unit configured to determine a permission level given to the user specified by the authenticating unit; and
a managing unit configured to manage, according to the permission level determined by the determining unit, information permitted to be disclosed, notified, or displayed to the user specified by the authenticating unit; and
an image processing apparatus configured to execute processing instructed by the user.

12. The system of claim 11, wherein the managing apparatus discloses only information related to the user specified by the authenticating unit.

13. The system of claim 11, wherein the managing apparatus discloses information related to the user specified by the authenticating unit and information that can be disclosed to all users.

14. A method for monitoring information of a log of jobs, comprising:
specifying a request source user;
acquiring a permission level given to the specified user; and
disclosing information according to the acquired permission level.

15. The method of claim 14, wherein only information related to the specified user is disclosed.

16. The method of claim 14, wherein information related to the specified user and information that can be disclosed to all users.

17. The method of claim 15, wherein information related to user different from the specified user is disclosed using a rule for not specifying the different user.

18. The method of claim 16, wherein information related to user different from the specified user is disclosed using a rule for not specifying the different user.

19. The method of claim 17, wherein the information concerning the different user is disclosed with a user name of the different user encoded.

20. The method of claim 18, wherein the information concerning the different user is disclosed with a user name of the different user encoded.
